(19) United States
(12) Patent Application Publication
(10) Pub. No.: US 2025/0269333 A1
(43) Pub. Date: Aug. 28, 2025

(54) LINED HOLLOW FIBER MEMBRANE WITH SANDWICH STRUCTURE, AND PREPARATION METHOD AND USE THEREOF

(71) Applicant: Tiangong University, Tianjin (CN)

(72) Inventors: Liang WANG, Tianjin (CN); Guojun GU, Tianjin (CN); Bin ZHAO, Tianjin (CN); Yinghui MO, Tianjin (CN); Xiangyu WANG, Tianjin (CN); Yafei CHEN, Tianjin (CN)

(21) Appl. No.: 19/030,016

(22) Filed: Jan. 17, 2025

(30) Foreign Application Priority Data
Feb. 23, 2024 (CN) 202410199464.3

(51) Int. Cl. B01D 69/08; B01D 69/12; B01D 71/34; B01D 71/48; C02F 3/12

(52) U.S. Cl. CPC B01D 69/088; B01D 69/125; B01D 71/34; B01D 71/48; C02F 3/1268; B01D 2323/04; B01D 2323/081; B01D 2323/12; B01D 2323/21823; B01D 2323/2187; B01D 2323/60; B01D 2325/04

(57) ABSTRACT

Provided are a lined hollow fiber membrane (HFM) with a sandwich structure, and a preparation method and use thereof. In the lined HFM with a sandwich structure, a membrane structure of the lined HFM includes an inner PVDF layer, a braided liner layer, and an outer PVDF layer in sequence from inside to outside.

### CROSS REFERENCE TO RELATED APPLICATION

This patent application claims the benefit and priority of Chinese Patent Application No. 202410199464.3 filed with the China National Intellectual Property Administration on Feb. 23, 2024, the disclosure of which is incorporated by reference herein in its entirety as part of the present application.

### TECHNICAL FIELD

The present disclosure relates to the technical field of hollow fiber membranes (HFMs), and in particular to a lined HFM with a sandwich structure, and a preparation method and use thereof.

### BACKGROUND

Membrane bioreactors are widely used in sewage and wastewater treatment due to high separation efficiency, desirable effluent quality, low sludge production, impact resistance, and compact structure. Hollow fiber membranes are widely used in the membrane bioreactors due to high packing density and large specific surface area. In order to effectively control the development of membrane fouling during operation and to maintain stable operation of the system, HFM-based components need to be frequently subjected to online air-water backwashing. Conventional HFM-based components have a relatively low mechanical strength and are prone to wire breakage under high-intensity air-water backwashing, which greatly reduces a service life of the HFM-based components. Introducing a support layer of braided liner tube into the HFM, namely preparing a lined HFM, is an effective means to improve a mechanical strength of membrane filaments, thereby ensuring the stable operation of a membrane bioreactor system.

The braided liner tube as a support layer is generally made of different materials from that of a selective skin layer for the HFM, thereby resulting in weak interface bonding and easy shedding of the skin layer during use. Therefore, it is particularly important to improve a bonding strength between the skin layer and the liner tube. Chinese patent CN102160967A discloses a method for improving an interfacial bonding strength of a liner-enhanced HFM tube by secondary coating. Compared with the casting solution, a hydrophobic nanopowder is added to a pre-coating transition layer blending stock solution, which could improve adhesion and hardness of the transition layer and its compatibility with a surface separation layer, resulting in that a volume shrinkage rate is extremely low during the phase conversion, and an interface stability is improved. Chinese patent CN106268361A discloses a process for pre-treating a liner tube. A pre-treatment solution used is one of a solvent, a non-solvent, or a solvent/non-solvent mixture for a polymer raw material of the casting solution. After the liner tube is immersed in the pre-treatment solution for a period of time, the excess pre-treatment solution is removed, and then the liner tube is restored to a round shape to perform spinning. This process can effectively improve a bonding strength between the skin layer and the liner tube, thus avoiding shedding of the skin layer. ZHU Mingxing et al. propose a method for surface modification of a braided liner tube using a silane coupling agent KH-550, which could improve surface roughness and specific surface area of the braided liner tube, promote a wetting process of the casting solution to the braided liner tube, and strengthen mechanical meshing and physical adsorption bonding between the casting solution and the braided liner tube, thereby greatly enhancing an interface bonding strength of a resulting composite membrane. However, the problem of material compatibility cannot be fundamentally solved by surface treatment of the braided liner tube alone, and a stability between the separation layer and the liner tube still needs to be improved.

### SUMMARY

In view of this, an object of the present disclosure is to provide a lined HFM with a sandwich structure, and a preparation method and use thereof. In the present disclosure, only a casting solution needs to be coated on an outer layer of a hydrophobic braided liner tube, and a membrane fiber cross-section of the prepared HFM presents a sandwich structure of “PVDF layer-braided liner layer-PVDF layer” from outside to inside. The inner PVDF layer and outer PVDF layer penetrate each other through infiltrating fabric gaps of the braided liner tube, thereby effectively improving a bonding strength between an outer PVDF skin layer and the braided liner layer.

To achieve the above object, the present disclosure provides the following technical solutions:

Provided is a method for preparing a lined HFM with a sandwich structure, including the following steps:
subjecting polyvinylidene fluoride (PVDF), a solvent, an additive, and a porogen to heated mixing and then defoaming to obtain a casting solution, where a mass concentration of the PVDF in the casting solution is in a range of 10% to 20%;
subjecting a braided liner tube to hydrophobic modification to obtain a hydrophobic braided liner tube;
subjecting the casting solution and the hydrophobic braided liner tube to coaxial spinning, air bath treatment, and coagulation bath treatment in sequence to obtain a membrane filament, where the hydrophobic braided liner tube passes through an inner layer of a double-layer spinneret and the casting solution passes through an outer layer of the double-layer spinneret during the coaxial spinning; and
subjecting the membrane filament to water immersion and glycerol immersion in sequence to obtain an immersed membrane filament, and then drying the immersed membrane filament to obtain the lined HFM with the sandwich structure.

In some embodiments, a material of the braided liner tube includes polyethylene terephthalate (PET).

In some embodiments, the additive in the casting solution comprises one selected from the group consisting of a macromolecular additive and a micromolecular additive, the macromolecular additive comprises one selected from the group consisting of polyvinylpyrrolidone (PVP) and polyvinyl alcohol (PVA); and the micromolecular additive comprises one selected from the group consisting of ethanol and glycerol.

In some embodiments, the casting solution includes the following components by weight percentage: 10% to 20% of the PVDF, 3% to 10% of the macromolecular additive, 0% to 3% of the micromolecular additive, 3% to 10% of a porogen, and 60% to 84% of a solvent.

In some embodiments, the hydrophobic modification is conducted by a process comprising:
subjecting the braided liner tube to cleaning with a NaOH solution and treating with a low-temperature plasma in sequence, where an atmosphere for the low-temperature plasma includes argon and carbon tetrafluoride.

In some embodiments, during the coaxial spinning, the casting solution is at a temperature of 60° C. to 85° C., and a roller has a pulling speed of 5 m/min to 50 m/min;
the air bath treatment is conducted with an air gap of 0.5 cm to 30 cm; and
a liquid of a coagulation bath for the coagulation bath treatment is water, and the coagulation bath treatment is conducted at a temperature of 30° C. to 70° C. for 2 seconds to 30 seconds.

In some embodiments, the water immersion is conducted for 12 h to 48 h, and the glycerol immersion is conducted for 12 h to 48 h.

The present disclosure further provides a lined HFM with a sandwich structure prepared by the preparation method, where a membrane structure of the lined HFM includes an inner PVDF layer, a braided liner layer, and an outer PVDF layer in sequence from inside to outside.

In some embodiments, the inner PVDF layer has a thickness of 100 μm to 200 μm, the braided liner layer has a thickness of 200 μm to 1,000 μm, and the outer PVDF layer has a thickness of 100 μm to 200 μm; and
the membrane filament of the lined HFM has an inner diameter of 0.7 mm to 1.9 mm.

The present disclosure further provides use of the lined HFM with a sandwich structure in a membrane bioreactor.

The present disclosure provides a method for preparing a lined HFM with a sandwich structure, including: subjecting PVDF, a solvent, an additive, and a porogen to heated mixing and defoaming to obtain a casting solution, where the casting solution includes 10% to 20% of the PVDF by mass concentration; subjecting a braided liner tube to hydrophobic modification to obtain a hydrophobic braided liner tube; subjecting the casting solution and the hydrophobic braided liner tube to coaxial spinning, air bath treatment, and coagulation bath treatment in sequence to obtain a membrane filament, where the hydrophobic braided liner tube passes through an inner layer of a double-layer spinneret and the casting solution passes through an outer layer of the double-layer spinneret during the coaxial spinning; and subjecting the membrane filament to water immersion and glycerol immersion in sequence to obtain an immersed membrane filament, and then drying the immersed membrane filament to obtain the lined HFM with the sandwich structure. In the present disclosure, a viscosity of the casting solution is reduced by controlling a mass concentration of the PVDF in the casting solution to 10% to 20%. In the present disclosure, the braided liner tube is subjected to hydrophobic modification, which could improve a solvent wettability of the braided liner tube. In the present disclosure, only the casting solution needs to be coated on an outer layer of the hydrophobic braided liner tube, and the operation is simple. By reducing a viscosity of the casting solution, improving a solvent wettability of the braided liner tube, and extending an infiltration time, the casting solution coated on the outer surface of the braided liner tube can be fully infiltrated and then penetrates braided fibers. In this way, phase separation occurs both inside and outside the braided liner tube, and the lined HFM with a sandwich structure of “PVDF layer-braided liner layer-PVDF layer” is obtained. The inner and outer PVDF layers penetrate each other through fabric gaps of the braided liner tube to form an interlocking structure, thereby improving a bonding strength between a PVDF skin layer and the braided liner layer and preventing the skin layer from shedding.

Moreover, the method of the present disclosure has a simple process and a low cost, and is easy to realize industrialized mass production.

In the present disclosure, only the casting solution needs to be coated on the outer layer of the hydrophobic braided liner tube, and the lined HFM with a sandwich structure of “PVDF layer-braided liner layer-PVDF layer” can be prepared. The inner and outer PVDF layers penetrate each other through infiltrating fabric gaps of the braided liner tube, thereby improving a bonding strength between an outer PVDF skin layer and the braided liner layer, avoiding the skin layer shedding, and extending service life and application range of the HFM. This interlocking structure can overcome the problem of an unstable structure between the separation layer and the liner layer in a “separation layer-liner layer” structure of a traditional lined HFM as well as the problem of easy shedding during frequent backwashing, thereby improving the stability of the membrane structure. Moreover, this interlocking structure makes the HFM possible to operate in both internal pressure and external pressure. The lined HFM with a sandwich structure can withstand high-intensity online water-air backwashing in the membrane bioreactor, and is suitable for the treatment of high-turbidity and highly-polluted wastewater as well as high-biomass membrane bioreactors. The results of examples show that the lined HFM with a sandwich structure treats domestic sewage in the form of a membrane bioreactor, showing a membrane flux of (10-15) LMH under stable operation at 50 kPa, and an effluent turbidity of less than 1 NTU.

### BRIEF DESCRIPTION OF THE DRAWINGS

FIG. 1 shows a cross-sectional view of the lined HFM with a sandwich structure according to an embodiment of the present disclosure;

FIG. 2 shows an electron microscope photograph of the cross-section of the lined HFM with a sandwich structure obtained in Example 1; and

FIG. 3 shows an electron microscope photograph of the cross-section of the lined HFM obtained in Comparative Example 1.

### DETAILED DESCRIPTION OF THE EMBODIMENTS

The present disclosure provides a method for preparing a lined HFM with a sandwich structure, including:
subjecting polyvinylidene fluoride (PVDF), a solvent, an additive, and a porogen to heated mixing and then defoaming to obtain a casting solution, where a mass concentration of the PVDF in the casting solution is in a range of 10% to 20%;
subjecting a braided liner tube to hydrophobic modification to obtain a hydrophobic braided liner tube;
subjecting the casting solution and the hydrophobic braided liner tube to coaxial spinning, air bath treatment, and coagulation bath treatment in sequence to obtain a membrane filament, where the hydrophobic braided liner tube passes through an inner layer of a double-layer spinneret and the casting solution passes through an outer layer of the double-layer spinneret during the coaxial spinning; and
subjecting the membrane filament to water immersion and glycerol immersion in sequence to obtain an immersed membrane filament, and then drying the immersed membrane filament to obtain the lined HFM with the sandwich structure.

In the present disclosure, a PVDF, a solvent, an additive, and a porogen are subjected to heated mixing and then defoaming to obtain a casting solution. In the present disclosure, in some embodiments, the additive in the casting solution includes a macromolecular additive and/or a micromolecular additive. In some embodiments, the macromolecular additive includes PVP and/or PVA. In some embodiments, the PVP has a weight-average molecular weight of 10 K to 360 K, preferably 50 K to 300 K, and more preferably 100 K to 200 K. In some embodiments, the PVA has a weight-average molecular weight of 25 K to 300 K, preferably 50 K to 200 K, and more preferably 100 K to 150 K.

In the present invention, in some embodiments, the micromolecular additive includes ethanol and/or glycerol.

In the present disclosure, in some embodiments, the casting solution includes the following components by weight percentage:

| | |
|---|---|
| the PVDF | 10%-20%; |
| the macromolecular additive | 3%-10%; |
| the micromolecular additive | 0%-3%; |
| the porogen | 3%-10%; and |
| the solvent | 60%-84%. |

In the present disclosure, in some embodiments, in terms of mass percentage, the casting solution includes 10% to 20%, preferably 12% to 18%, and more preferably 15% of the PVDF by mass percentage. In some embodiments, the PVDF has a molecular weight of 100 K to 650 K, preferably 200 K to 400 K, and more preferably 300 K.

In the present disclosure, in some embodiments, in terms of mass percentage, the casting solution includes 3% to 10%, preferably 5% to 8% of the macromolecular additive by mass percentage.

In the present disclosure, in some embodiments, in terms of mass percentage, the casting solution includes 0% to 3%, preferably 1% to 2% of the micromolecular additive by mass percentage.

In the present disclosure, in some embodiments, in terms of mass percentage, the casting solution includes 3% to 10%, preferably 5% to 8% of the porogen by mass percentage. In some embodiments, the porogen is polyethylene glycol (PEG) and/or polypropylene glycol (PPG). In some embodiments, the porogen has a molecular weight of 200 to 6,000, preferably 500 to 5,000, and more preferably 1,000 to 3,000.

In the present disclosure, in some embodiments, in terms of mass percentage, the casting solution includes 60% to 84%, preferably 70% to 80% of the solvent by mass percentage. In some embodiments, the solvent is an organic solvent, and preferably one or more of N,N-dimethylacetamide (DMA), N,N-dimethylformamide (DMF), and dimethyl sulfoxide (DMSO).

In the present disclosure, a viscosity of the casting solution is reduced by controlling a mass concentration of the PVDF to 10% to 20% and a mass concentration of the macromolecular additive to 3% to 10% in the casting solution.

In the present disclosure, in some embodiments, the heated mixing is conducted at a temperature of 60° C. to 85° C., and preferably 70° C. to 80° C. In some embodiments, the heated mixing is conducted for 12 h to 24 h, and preferably 15 h to 20 h. In some embodiments, the heated mixing is conducted under stirred mixing.

In the present disclosure, in some embodiments, the defoaming is conducted for 12 h to 24 h, and preferably 15 h to 20 h.

In the present disclosure, a braided liner tube is subjected to hydrophobic modification to obtain a hydrophobic braided liner tube. In some embodiments, a material of the braided liner tube is PET. In some embodiments, the braided liner tube has a wall thickness of 200 μm to 1,000 μm, and preferably 500 μm to 800 μm. In some embodiments, an outer diameter of the braided liner tube is 1 mm to 3 mm, and preferably 2 mm.

In the present disclosure, the hydrophobic modification is conducted by a process including:

subjecting the braided liner tube to cleaning with a NaOH solution and treating with a low-temperature plasma in sequence.

In the present disclosure, in some embodiments, the NaOH solution has a mass concentration of 3% to 7%, and preferably 5%. In some embodiments, the cleaning with the NaOH solution is conducted for 0.5 h to 2 h. The cleaning with the NaOH solution can effectively remove oil stains on the braided liner tube and slightly corrode a surface of the braided liner tube to increase the roughness.

In the present disclosure, in some embodiments, the term “low-temperature plasma” is a proprietary technical term. Low temperature plasma is also called “non-equilibrium plasma”, in which temperature of ions and neutral particles is only in a range of 300 K to 500 K; thus, the temperature of the whole system is mild.

In the present disclosure, in some embodiments, an atmosphere for the low-temperature plasma includes argon and carbon tetrafluoride. In some embodiments, a volume ratio of the argon to the carbon tetrafluoride is in a range of 1:2 to 2:1, and preferably 2:1.

In the present disclosure, in some embodiments, the treating with the low-temperature plasma is conducted at a power of 30 W to 100 W, and preferably 50 W. In some embodiments, the treating with the low-temperature plasma is conducted for 30 s to 600 s, and preferably 60 s. The treating with the low-temperature plasma can introduce fluorine-containing functional groups on a fiber surface of the braided liner tube, thereby improving hydrophobicity of the liner tube.

In the present disclosure, after the casting solution and the hydrophobic braided liner tube are obtained, the casting solution and the hydrophobic braided liner tube are subjected to coaxial spinning, air bath treatment, and coagulation bath treatment in sequence to obtain a membrane filament; where the hydrophobic braided liner tube passes through an inner layer of a double-layer spinneret and the casting solution passes through an outer layer of the double-layer spinneret during the coaxial spinning. In some embodiments, the double-layer spinneret for the coaxial spinning has an outer layer inner radius of 1.1 mm to 3.2 mm, and preferably 1.5 mm to 2.5 mm. In some embodiments, the double-layer spinneret for the coaxial spinning has an inner layer inner radius of 0.7 mm to 1.9 mm, and preferably 1 mm to 1.5 mm.

In the present disclosure, in some embodiments, during the coaxial spinning, the casting solution is at a temperature of 60° C. to 85° C., and preferably 70° C. to 80° C.; and a roller has a pulling speed of 5 m/min to 50 m/min, and preferably 10 m/min to 30 m/min. The pulling speed of the roller is controlled at a relatively low rate of 5 m/min to 50 m/min, so as to prolong the infiltration time of the casting solution in the air bath treatment.

In the present disclosure, in some embodiments, the air bath treatment is conducted with an air gap of 0.5 cm to 30 cm, and preferably 5 cm to 20 cm. In some embodiments, a liquid of a coagulation bath for the coagulation bath treatment is water, and the coagulation bath treatment is conducted at a temperature of 30° C. to 70° C., and preferably 40° C. to 60° C. In some embodiments, the coagulation bath treatment is conducted for 2 seconds to 30 seconds, and preferably 10 s to 20 s. The coaxial spinning can ensure that the casting solution permeates from the outer surface of the braided liner tube to the inner surface of the braided liner tube and completes the phase conversion, thereby forming an inner PVDF layer and an outer PVDF layer.

In the present disclosure, the membrane filament is subjected to water immersion and glycerol immersion in sequence to obtain an immersed membrane filament, and then the immersed membrane filament is subjected to drying to obtain the lined HFM with a sandwich structure.

In the present disclosure, in some embodiments, the water immersion is conducted for 12 h to 48 h, and preferably 24 h to 36 h. In some embodiments, the glycerol immersion is conducted for 12 h to 48 h, and preferably 24 h to 36 h. The water immersion can further remove the solvent and additive; and the glycerol immersion can maintain the hydrophilicity of the membrane.

In the present disclosure, in some embodiments, the drying is natural air-drying.

The present disclosure further provides a lined HFM with a sandwich structure prepared by the method described above, where a membrane structure of the lined HFM includes an inner PVDF layer, a braided liner layer, and an outer PVDF layer in sequence from inside to outside.

In the present disclosure, the lined HFM with a sandwich structure presents a sandwich structure of “PVDF layer-braided liner layer-PVDF layer”. The inner and outer PVDF layers penetrate each other through infiltrating fabric gaps of the braided liner tube.

In the present disclosure, in some embodiments, the inner PVDF layer has a thickness of 100 μm to 200 μm, preferably 120 μm to 180 μm, and more preferably 150 μm.

In the present disclosure, in some embodiments, the braided liner layer is made of PET. In some embodiments, the braided liner layer has a thickness of 200 μm to 1,000 μm, preferably 400 μm to 800 μm, and more preferably 500 μm to 600 μm.

In the present disclosure, in some embodiments, the outer PVDF layer has a thickness of 100 μm to 200 μm, preferably 120 μm to 180 μm, and more preferably 150 μm.

In the present disclosure, in some embodiments, the membrane filament of the HFM has an inner diameter of 0.7 mm to 1.9 mm, and preferably 1 mm to 1.5 mm.

In the present disclosure, in some embodiments, the lined HFM with a sandwich structure has an effective membrane pore size of 0.01 μm to 1 μm, preferably 0.05 μm to 0.8 μm, and more preferably 0.1 μm to 0.5 μm.

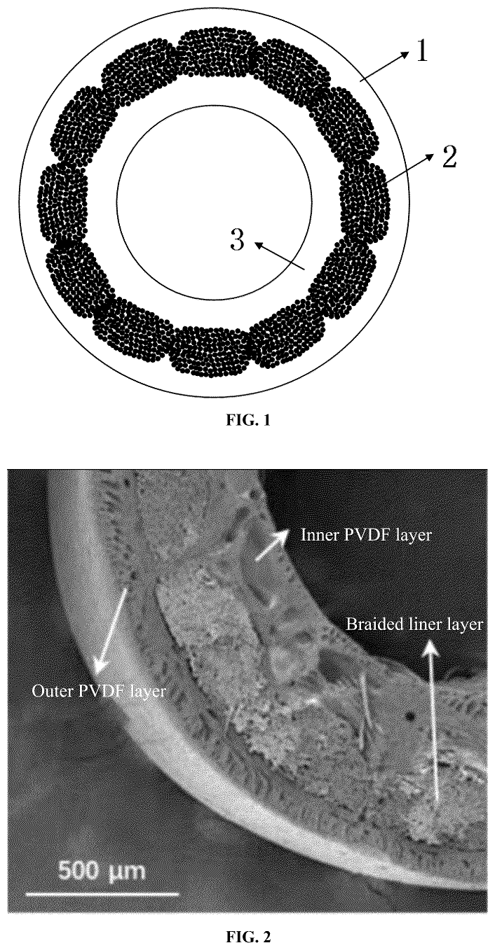

In the present disclosure, FIG. 1 shows a cross-sectional view of the lined HFM with a sandwich structure according to one embodiment of the present disclosure. In FIG. 1, 1 represents an outer PVDF layer, 2 represents a braided liner layer, and 3 represents an inner PVDF layer.

The present disclosure further provides use of the lined HFM with the sandwich structure in a membrane bioreactor. In the present disclosure, in some embodiments, the membrane bioreactor is used for sewage and wastewater treatment.

The lined HFM with a sandwich structure, and the preparation method and the use thereof provided by the present disclosure will be described in detail in connection with the following examples, but they should not be construed as limiting the scope of the present disclosure.

In all examples, the term “average molecular weight” refers to “weight average molecular weight”.

### Example 1

42 g of PVDF with an average molecular weight of 350 K, 180 g of DMA, 20 g of PVP with an average molecular weight of 40 K, 5 g of glycerol, and 13 g of PEG with a molecular weight of 6,000 were fully stirred at 70° C. for 12 h and defoamed for 24 h to obtain a casting solution.

A PET braided liner tube with a diameter of 2.5 mm and a wall thickness of 300 μm was cleaned with a 5 wt. % NaOH solution, and then, the PET braided liner tube was dried and treated in a low-temperature plasma device to obtain a pretreated liner tube, where the low-temperature plasma was conducted at a volume ratio of argon to carbon tetrafluoride of 2:1, and a power of 50 W for 60 s.

The pretreated liner tube was installed on a spinning machine and passed coaxially and vertically through a center of a spinneret, where the casting solution was kept at 70° C., a pulling speed of the liner tube was 15 m/min, and an air gap was 30 cm. Then, a resulting material was subjected to a coagulation bath treatment with water at 50° C. for 10 s. A resulting coagulation membrane was rinsed in 30° C. water for 12 h, immersed in a glycerol solution for 12 h, and dried to obtain a lined HFM with a sandwich structure.

FIG. 2 shows an electron microscope photograph of the cross-section of the lined HFM with a sandwich structure. As shown in FIG. 2, the inner and outer PVDF layers infiltrate into fabric gaps of the liner tube and penetrate each other to form an interlocking structure.

### Example 2

31 g of PVDF with an average molecular weight of 350 K, 187 g of DMA, 10 g of PVP with an average molecular weight of 30 K, 7 g of glycerol, and 25 g of PEG with a molecular weight of 6,000 were fully stirred at 70° C. for 12 h and defoamed for 24 h to obtain a casting solution. The modification of the liner tube and membrane preparation process were conducted according to the method of Example 1. The cross-section of the obtained lined HFM presented a sandwich structure of “PDF layer-braided liner layer-PVDF layer”.

### Example 3

49 g of PVDF with an average molecular weight of 650 K, 159 g of DMA, 26 g of PVP with an average molecular weight of 30 K, 6 g of glycerol, and 20 g of PEG with a molecular weight of 2,000 were fully stirred at 70° C. for 12 h and defoamed for 24 h to obtain a casting solution. The modification of the liner tube and membrane preparation process were conducted according to the method of Example 1. The cross-section of the obtained lined HFM presented a sandwich structure of “PDF layer-braided liner layer-PVDF layer”.

### Comparative Example 1

49 g of PVDF with an average molecular weight of 650 K, 159 g of DMA, 26 g of PVP with an average molecular weight of 30 K, 6 g of glycerol, and 20 g of PEG with a molecular weight of 2,000 were fully stirred at 70° C. for 12 h and defoamed for 24 h to obtain a casting solution.

A PET braided liner tube with a diameter of 2.5 mm and a wall thickness of 300 μm was cleaned with a 5 wt. % NaOH solution. The cleaned liner tube was installed on a spinning machine and passed coaxially and vertically through a center of a spinneret, where the casting solution was kept at 70° C., a pulling speed of the liner tube was 15 m/min, and an air gap was 30 cm. Then, a resulting material was subjected to a coagulation bath treatment with water at 50° C. for 10 s. A resulting coagulation membrane was rinsed in 30° C. water for 12 h, immersed in a glycerol solution for 12 h, and dried to obtain a lined HFM with no internal skin layer in the cross-section of the obtained lined HFM.

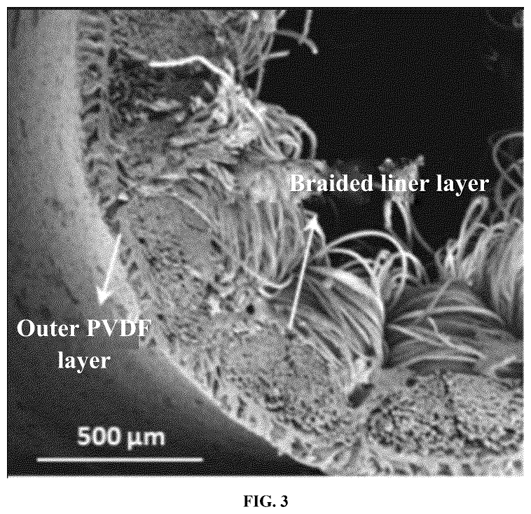

FIG. 3 shows an electron microscope photograph of the cross-section of the lined HFM. As shown in FIG. 3, the cross-section of the obtained lined HFM does not show a sandwich structure of “PDF layer-braided liner layer-PVDF layer”.

### Comparative Example 2

55 g of PVDF with an average molecular weight of 650 K, 140 g of DMA, 39 g of PVP with an average molecular weight of 58 K, 6 g of glycerol, and 20 g of PEG with a molecular weight of 2,000 were fully stirred at 70° C. for 12 h and defoamed for 24 h to obtain a casting solution.

The modification of the liner tube was conducted according to the method of Example 1. The liner tube was installed on a spinning machine and passed coaxially and vertically through a center of a spinneret, where the casting solution was kept at 70° C., a pulling speed of the liner tube was 15 m/min, and an air gap was 30 cm. Then, a resulting material was subjected to a coagulation bath treatment with water at 50° C. for 10 s. A resulting coagulation membrane was rinsed in 30° C. water for 12 h, immersed in a glycerol solution for 12 h, and dried to obtain a lined HFM with no internal skin layer in the cross-section of the obtained lined HFM.

### Comparative Example 3

49 g of PVDF with an average molecular weight of 650 K, 159 g of DMA, 26 g of PVP with an average molecular weight of 30 K, 6 g of glycerol, and 20 g of PEG with a molecular weight of 2,000 were fully stirred at 70° C. for 12 h and defoamed for 24 h to obtain a casting solution.

The modification of the liner tube was conducted to the method of Example 1. The liner tube was installed on a spinning machine and passed coaxially and vertically through a center of a spinneret, where the casting solution was kept at 70° C., a pulling speed of the liner tube was 60 m/min, and an air gap was 10 cm. Then, a resulting material was subjected to a coagulation bath treatment with water at 50° C. for 10 s. A resulting coagulation membrane was rinsed in 30° C. water for 12 h, immersed in a glycerol solution for 12 h, and dried to obtain a lined HFM with no internal skin layer in the cross-section of the obtained lined HFM.

### Performance Testing

### i) Peeling Strength Test Method of the Skin Layer:

A bonding strength between the braided liner tube and the skin layer was tested by an isomorphic internal pressure method: a 15 cm membrane filament sample was casted as a dead-end filtration membrane assembly, and internal pressure backwash was conducted with pure water as a medium at 0.1 MPa for 2 h. Thereafter, the internal pressure was gradually increased by 0.02 MPa each time and maintained for 0.5 h. A pressure when the surface separation layer was damaged was a peeling strength of the membrane filament.

According to the test, compared with the HFM obtained in Comparative Example 1, the peeling strengths of the skin layers of the lined HFMs with a sandwich structure in Examples 1, 2, and 3 are increased by 56%, 11%, and 50%, respectively.

### ii) Water Treatment Test:

The lined HFM in Example 1 was used to treat domestic sewage in the form of an MBR, with an initial turbidity of (30-40) NTU. A membrane flux was measured to be 15 LMH under stable operation at 50 kPa, and an effluent turbidity was less than 1 NTU.

The lined HFM in Example 2 was used to treat domestic sewage in the form of an MBR. A membrane flux was measured to be 12 LMH under stable operation at 50 kPa, and an effluent turbidity was less than 1 NTU.

The lined HFM in Example 3 was used to treat domestic sewage in the form of an MBR. A membrane flux was measured to be 10 LMH under stable operation at 50 kPa, and an effluent turbidity was less than 1 NTU.

The above examples are merely preferred embodiments of the present disclosure. It should be noted that those skilled in the art may further make several improvements and modifications without departing from the principle of the present disclosure, but such improvements and modifications should be deemed as falling within the scope of the present disclosure.

What is claimed is:

1. A method for preparing a lined hollow fiber membrane (HFM) with a sandwich structure, comprising:
subjecting polyvinylidene fluoride (PVDF), a solvent, an additive, and a porogen to heated mixing and then defoaming to obtain a casting solution, wherein a mass concentration of the PVDF in the casting solution is in a range of 10% to 20%;
subjecting a braided liner tube to hydrophobic modification to obtain a hydrophobic braided liner tube;
subjecting the casting solution and the hydrophobic braided liner tube to coaxial spinning, air bath treatment, and coagulation bath treatment in sequence to obtain a membrane filament, wherein the hydrophobic braided liner tube passes through an inner layer of a double-layer spinneret and the casting solution passes through an outer layer of the double-layer spinneret during the coaxial spinning; and
subjecting the membrane filament to water immersion and glycerol immersion in sequence to obtain an immersed membrane filament, and then drying the immersed membrane filament to obtain the lined HFM with the sandwich structure.

2. The method of claim 1, wherein a material of the braided liner tube comprises polyethylene terephthalate (PET).

3. The method of claim 1, wherein the additive in the casting solution comprises one selected from the group consisting of a macromolecular additive and a micromolecular additive, the macromolecular additive comprises one selected from the group consisting of polyvinylpyrrolidone (PVP) and polyvinyl alcohol (PVA); and the micromolecular additive comprises one selected from the group consisting of ethanol and glycerol.

4. The method of claim 3, wherein the casting solution comprises the following components by weight percentage: 10% to 20% of the PVDF, 3% to 10% of the macromolecular additive, 0% to 3% of the micromolecular additive, 3% to 10% of a porogen, and 60% to 84% of a solvent.

5. The method of claim 1, wherein the hydrophobic modification is conducted by a process comprising:
subjecting the braided liner tube to cleaning with a NaOH solution and treating with a low-temperature plasma in sequence, wherein an atmosphere for the low-temperature plasma comprises argon and carbon tetrafluoride.

6. The method of claim 1, wherein during the coaxial spinning, the casting solution is at a temperature of 60° C. to 85° C., and a roller has a pulling speed of 5 m/min to 50 m/min;
the air bath treatment is conducted with an air gap of 0.5 cm to 30 cm; and
a liquid of a coagulation bath for the coagulation bath treatment is water, and the coagulation bath treatment is conducted at a temperature of 30° C. to 70° C. for 2 seconds to 30 seconds.

7. The method of claim 1, wherein the water immersion is conducted for 12 h to 48 h, and the glycerol immersion is conducted for 12 h to 48 h.

8. A lined HFM with a sandwich structure prepared by the method of claim 1, wherein a membrane structure of the lined HFM comprises an inner PVDF layer, a braided liner layer, and an outer PVDF layer in sequence from inside to outside.

9. The lined HFM with the sandwich structure of claim 8, wherein a material of the braided liner tube comprises PET.

10. The lined HFM with the sandwich structure of claim 8, wherein the additive in the casting solution comprises one selected from the group consisting of a macromolecular additive and a micromolecular additive, the macromolecular additive comprises one selected from the group consisting of PVP and PVA; and the micromolecular additive comprises one selected from the group consisting of ethanol and glycerol.

11. The lined HFM with the sandwich structure of claim 10, wherein the casting solution comprises the following components by weight percentage: 10% to 20% of the PVDF, 3% to 10% of the macromolecular additive, 0% to 3% of the micromolecular additive, 3% to 10% of a porogen, and 60% to 84% of a solvent.

12. The lined HFM with the sandwich structure of claim 8, wherein the inner PVDF layer has a thickness of 100 μm to 200 μm, the braided liner layer has a thickness of 200 μm to 1,000 μm, and the outer PVDF layer has a thickness of 100 μm to 200 μm; and
the membrane filament of the lined HFM has an inner diameter of 0.7 mm to 1.9 mm.

13. A membrane bioreactor, wherein the membrane bioreactor contains the lined HFM with the sandwich structure of claim 8.

14. The membrane bioreactor of claim 13, wherein a material of the braided liner tube comprises PET.

15. The membrane bioreactor of claim 13, wherein the additive in the casting solution comprises one selected from the group consisting of a macromolecular additive and a micromolecular additive, the macromolecular additive comprises one selected from the group consisting of PVP and PVA; and the micromolecular additive comprises one selected from the group consisting of ethanol and glycerol.

16. The membrane bioreactor of claim 15, wherein the casting solution comprises the following components by weight percentage: 10% to 20% of the PVDF, 3% to 10% of the macromolecular additive, 0% to 3% of the micromolecular additive, 3% to 10% of a porogen, and 60% to 84% of a solvent.

17. The membrane bioreactor of claim 13, wherein the inner PVDF layer has a thickness of 100 μm to 200 μm, the braided liner layer has a thickness of 200 μm to 1,000 μm, and the outer PVDF layer has a thickness of 100 μm to 200 μm; and
the membrane filament of the lined HFM has an inner diameter of 0.7 mm to 1.9 mm.
